(19) United States
(12) Patent Application Publication
(10) Pub. No.: US 2005/0083809 A1
(43) Pub. Date: Apr. 21, 2005

(54) Data reproducing apparatus and program for performing a data reproducing process

(75) Inventor: Hitoshi Katou, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: CASIO COMPUTER CO., LTD., Tokyo (JP)

(21) Appl. No.: 10/961,657

(22) Filed: Oct. 8, 2004

(30) Foreign Application Priority Data
Oct. 15, 2003 (JP) 2003-354681

(51) Int. Cl. G11B 5/09

(52) U.S. Cl. 369/47.32; 369/53.31

(57) ABSTRACT

CPU 16 and a memory controller 15 increment a writing address from a starting address every time when data is written into a shock memory 14, and increment a reproducing address from a starting address, thereby writing data read out by a pickup 12 to the writing address in the shock memory 14. Further, CPU 16 and the memory controller 15 suspend operation for reading out data from the shock memory 14 until the writing address reaches an accumulation judging address, and start the operation for reading out data from the reproducing address of the shock memory 14 when the writing address has reached the accumulation judging address. Even if a pickup for reading data from a recording medium such as CD is in a transient state from a stop state or from a fast forward state to a reproducing state, generation of a disconnected sound is prevented.

### BACKGROUND OF THE INVENTION

1. Field of the Invention

The present invention relates to a data reproducing apparatus for reproducing data recorded on a recording medium such as a storage disc and to a program for performing a data reproducing process.

2. Description of the Related Art

On a recording medium such as a compact disc (CD), data including music data is recorded on a pit series formed along concentric tracks provided thereon. In a data reproducing apparatus for reproducing data recorded on CD, an installed CD is driven by a spindle motor, a light beam such as a laser beam is emitted to the tracks on CD, and changes in a reflected light caused by the pits formed in the tracks are detected by a pickup to reproduce data. The pickup operates under a tracking control and a focusing control to reproduce data. Since the pickup does not contact with a recording surface of CD to reproduce data, the data reproducing apparatus has an advantage that the recording surface of CD receives no damage during the reproducing operation. When there is an error in the reproduced data, such error may be corrected by a digital signal processing. On the contrary, the data reproducing apparatus has a disadvantage that in case that unexpected force is applied to the pickup due to an external vibration, shock, or other cause, the so-called “sound-skipping phenomenon” happens and such sound skipping cannot be corrected by an error correction in the digital signal process.

To solve the above disadvantage, the so-called shockproof reproducing function is widely used in data reproducing apparatuses. The shockproof reproducing function employs a memory control method, in which the pickup reads out data from CD and writes the same data into a memory at a rate higher than a rate at which the data is reproduced, and as a result the data is written into the memory within a time period of one several-th of a time period in which the data is read out. In the memory control method, if unexpected force is applied to the pickup due to a vibration, shock, or other cause, and a tracking control and a focusing control are disturbed, resulting in errors in the read out data which can not be corrected, the data may be read out and written in the memory again during the time difference between the time period of reading out data and that of writing data. There have been proposed many data reproducing apparatuses using such memory control method. Typical structure of the conventional data reproducing apparatuses will be described hereafter.

In a disc player disclosed in Japanese laid-open patent application No. 7-14309, an earthquake resistant memory controller and DRAM compose the shockproof reproducing function. Either a shockproof reproducing mode or a normal reproducing mode is automatically selected depending on how many times the sound skipping happens during a certain period of time. In the present arrangement, even if the sound skipping should happen often due to external vibration, continuity of the reproduced signal may be secured without troubling the user with manually selecting the mode. If such shockproof reproducing function is employed in CD player for automobile or in a portable CD player, useless power consumption is reduced, extending a life time of a battery.

Further, in a display device of CD reproducing apparatus with the shockproof function disclosed in Japanese laid-open patent application No. 8-203254, audio data of CD is previously stored in a memory at a speed which is two times higher than the normal reproducing speed for a predetermined period of time through a pickup, a signal processing circuit and a shockproof circuit, and the audio data stored in the memory is output to a speaker at a normal reproducing speed with audio-data reading operation of the pickup remaining in a pause state. Even when sound skipping should happen, outputting operation of the audio data stored in the memory keeps outputting the audio data, and operation for restarting data-reading operation of the pickup is repeatedly performed before all the stored audio data has been output to secure continuity of the reproducing signal. In an optical disc reproducing apparatus of Japanese laid-open patent application No. 8-335364, an optical disc is driven at a rotational speed higher than the normal rotational speed to store audio data in a first memory. When a “track jump” or “out of focus” is detected, an instruction is immediately issued, and thereby a previous track is re-accessed, which track was accessed before the audio signal is disconnected, and input operation for inputting the audio signal at a high speed ceases and no data is supplied to the first memory to be stored therein. Meanwhile, the reproducing apparatus is controlled so as to keep outputting the audio signal from the first memory at the normal speed, and thereby a music signal is not disconnected, and the reproducing apparatus re-starts the reproducing operation before all the data stored in the memory has been outputted, preventing sound skipping due to an external vibration. Japanese laid-open patent application No. 10-112124 discloses a disc reproducing apparatus that reproduces music by reading out music data from a storing means in which music data read out from a disc type recording medium is temporarily stored. The music data is written into recording means at a rate higher than a rate at which music is reproduced, until music data that is stored therein and is not read out reaches a certain amount. After the music data that has been stored in the recording means and has not been read out reaches a certain amount, the music data is written into the recording means at a rate substantially same as the rate at which music is reproduced, which prevents generation of a disconnected sound and sound skipping, thereby enhancing shock-proof for continuous vibration, and preventing generation of a disconnected sound and sound skipping. Japanese laid-open patent application Nos. 2000-195174 and 2000-195175 disclose optical disc reproducing apparatuses that read out compressed music data at a high rate from a writable MD driven at a high rotational speed and write the same data onto DRAM, and read out the compressed music data from DRAM at a low rate. When DRAM becomes full of music data, writing operation ceases and an alarm signal notifying that DRAM has become full of data is given, and when the amount of data has decreased to an amount less than a standard amount, an alarm signal is generated to notify that there is left an empty space in DRAM. When the alarm signal notifying that DRAM has become full of data is given, the standard amount is increased or decreased depending on whether or not data is being read out from the proximity of end of an interval where data is continuously recorded, thereby preventing generation of sound skipping and reducing useless power consumption.

A disc reproducing apparatus disclosed in Japanese laid-open patent application No. 2002-15521 reproduces a signal recorded on a disc at a rate higher than the normal rate and records the signal on a memory. When shockproof is effective and outputs a signal reproduced from the memory signal even if an external shock is applied while the signal is reproduced from the memory, a low frequency emphasis is prohibited and a frequency characteristic is kept flat, thereby reducing chances of generation of sound skipping even when a strong vibration is applied due to a sound pressure produced by an built-in speaker. Further, an optical disc reproducing apparatus disclosed in Japanese laid-open patent application Nos. 2002-150666 and 2002-245721 previously reads out audio data from CD and stores the same in a memory for a shockproof function which prevents generation of sound skipping due to unexpected shock and vibration applied thereto. The reproducing apparatus performs communicating operation corresponding to sub code Q data of audio data, a tune number, and time.

In the conventional apparatuses described above, noting is described about in what state the pickup works to reproduce data. When the pickup reads data recorded on CD, CPU or the like generates a reproduction start instruction to make the pickup move in the radius direction of CD. But when the pickup starts reproducing operation from its stop or pause state, or from its fast forward reproducing, repeat-reproducing or fast rewind state, or when the pickup is in the steady state for performing reproducing operation, the pickup moves in different ways. In the transient state from its pause state or from its fast forward reproducing state to its normal reproducing state, the pickup receives heavy acceleration force or deacceleration force, but in the steady state in which the pickup performs the reproducing operation, the pickup does not receive acceleration or deacceleration force. That is, in the transient state from its pause state or from its fast forward reproducing state to its normal reproducing state, the tracking control or focusing control is easily disturbed, and therefore sound skipping is often generated.

Further, when the pickup receives an external shock or vibration in the transient state, a possibility of generation of sound skipping increases greatly due to a multiplier effect of the heavy acceleration or deacceleration force and the shock or vibration. For example, in an electronic instrument apparatus to which CD including music data can be installed, a keyboard of the apparatus is often played while CD is reproduced. When a user starts playing the keyboard at the same time as CD reproducing operation starts, the multiplier effect of the heavy acceleration or deacceleration force applied to the pickup and the shock or vibration greatly increases the possibility of generation of sound skipping.

Meanwhile, another disc reproducing apparatus has been proposed, for instance, in Japanese laid-open patent application No. 11-176080. In the disc reproducing apparatus, it is analyzed in detail how sound skipping happens to provide useful information for solving such disadvantage. It is pointed out in the above specification that sound skipping can be caused even in the apparatus with the shockproof function, and that such sound skipping can be caused by a defect of the optical pickup itself, a shift in setting position of the optical pickup, a physical factor of a circumstance in which the reproducing apparatus is used, and a defective signal processing for connecting sounds. To study in detail how sound skipping happens, a detecting process such as a process for comparing levels is executed based on variables and constants to be processed by a micro-computer for processing a signal, including an amount of data stored in a memory, and the resultants thereof are displayed. When sound skipping happens, it is judged whether such sound skipping is caused by a physical factor such as a defective recording medium or by a defective signal processing for connecting sounds.

The arrangement described above can determine what is the cause for the sound skipping, but nothing is described or suggested about a counter measure for preventing or suppressing generation of sound skipping.

### SUMMARY OF THE INVENTION

An object of the invention is to provide a data reproducing apparatus and a data processing program, which can suppress generation of sound skipping even if a pickup for reading out data recorded on a recording medium such as CD is in a transient state from its stop or pause state or from its fast moving state to its normal data reproducing state. According to one aspect of the present invention, there is provided command generating means for generating a control command for controlling data-reading operation.

And a writing address is incremented from a starting address every time when data is written into a predetermined memory, and a reproducing address is incremented from a starting address every time when data is read out from the memory, thereby setting a predetermined addresses.

Further, the data read out by the data-reading means is written to the writing address in the memory in accordance with a generated control command of requesting to start data-reproducing operation, and operation for reading out data from the memory is suspended until the writing address reaches the predetermined address, and operation starts for reading out data from the reproducing address in the memory when the writing address reaches the predetermined address.

With the above arrangement, the present invention has an advantage that the pickup for reading data recorded on a recording medium such as CD can prevent generation of sound skipping even in its transient state from its stop or pause state or from its fast moving state to its data reproducing state.

### BRIEF DESCRIPTION OF THE DRAWINGS

FIG. 1 is a view illustrating an external appearance of an electronic keyboard instrument according to an embodiment of the present invention.

FIG. 2 is a view illustrating an external appearance of an electronic drum instrument according to the embodiment of the present invention.

FIG. 3 is a block diagram showing a circuit configuration of the data reproducing apparatus used in the electronic keyboard instrument of FIG. 1 and/or in the electronic drum instrument of FIG. 2, and showing an electronic instrument system connected to the data reproducing apparatus.

FIG. 4 is a block diagram showing a circuit configuration of the electronic instrument system of FIG. 3.

FIG. 5 is an enlarged view showing a switch section for manipulating CD shown in FIGS. 1 and 2.

FIG. 6 is a view showing a relationship between data and addresses in a shock memory shown in FIG. 3.

FIG. 7A through FIG. 7E are views showing relationships between addresses and data of the shock memory 14, corresponding respectively to state transitions of CPU 16.

FIG. 8 is a flow chart of a main routine process to be performed by CPU 16 and a memory controller 15 shown in FIG. 3.

FIG. 9 is a flow chart of an initializing process of FIG. 8.

FIG. 10 is a flow chart of a setting process of FIG. 8.

FIG. 11 is a flow chart of the setting process to be connected to that of FIG. 10.

FIG. 12 is a flow chart of a memory control process of FIG. 8.

### DETAILED DESCRIPTION OF THE PREFERRED EMBODIMENTS OF THE INVENTION

Now, a data reproducing apparatus according to preferred embodiments of the present invention will be described in detail with reference to the accompanying drawings.

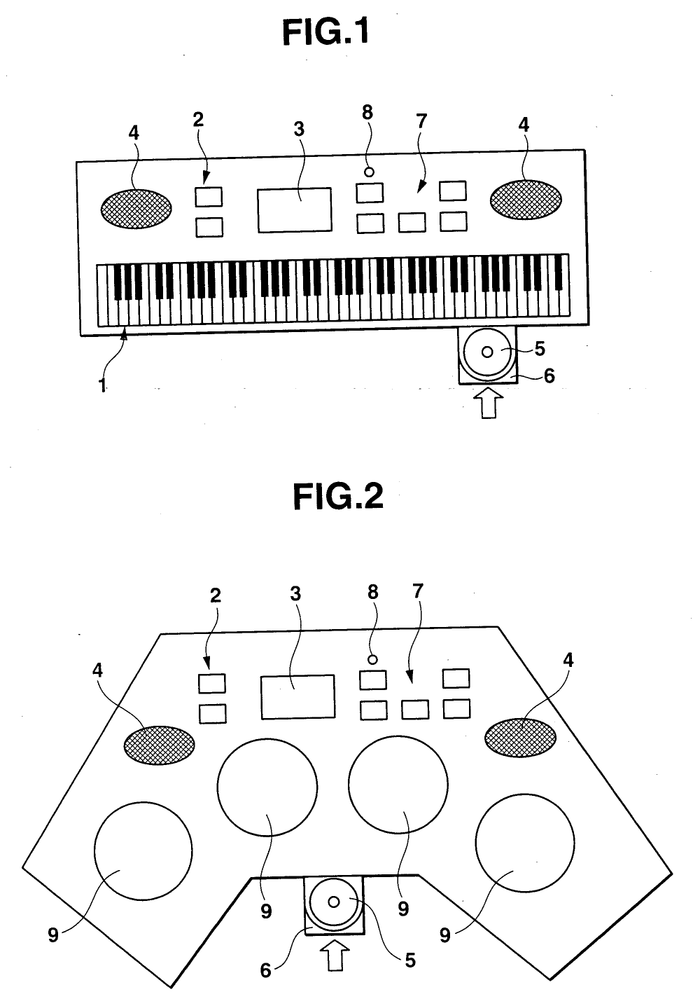

FIG. 1 is a view illustrating an external appearance of an electronic keyboard instrument using the data reproducing apparatus according to the embodiments of the present invention. The electronic keyboard instrument comprises a keyboard 1 for playing the instrument, a switch section 2 including a power switch, a display unit 3, speakers 4 and 4, and a tray 5 which comes into and/or comes out of an opening (not shown) formed in the instrument body. The tray 5 is formed with a CD receiving portion 6, and takes two positions in response to operation of an eject switch (not shown), one ejected position shown in FIG. 1 and other inserted position for reproducing the CD. A CD cover switch (not shown) is provided in the vicinity of the opening. The CD cover switch is turned on when the tray 5 takes the inserted position, and is turned off when the tray 5 takes the ejected position. The instrument is further provided with a a switch section 7 for driving CD and LED 8 for a repeat reproduction of CD. The electronic drum instrument combines a music reproduced from CD and a music played with keyboard 1 to the music reproduced from CD, outputting a composed music through the speakers 4 and 4.

FIG. 2 is a view illustrating an external appearance of an electronic drum instrument using the data reproducing apparatus according to the embodiments of the present invention. The electronic drum instrument is provided with performance sections such as drum pads 9, 9, 9, 9 to be played or beaten with sticks. Since other structures of the electronic drum instrument are similar to the electronic keyboard instrument shown in FIG. 1, further description thereof will be omitted. The electronic drum instrument combines a melody reproduced from CD and a drum performance by beating the drum pads 9 to the melody reproduced from CD, outputting the melody of CD composed with rhythm generated by the drum through the speakers 4 and 4.

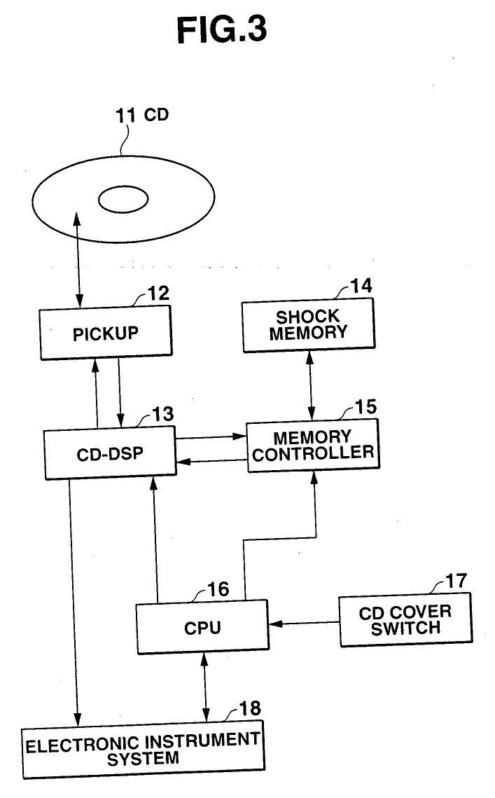

FIG. 3 is a block diagram showing a circuit configuration of the data reproducing apparatus used in the electronic keyboard instrument of FIG. 1 and/or in the electronic drum instrument of FIG. 2, and showing an electronic instrument system connected to the data reproducing apparatus. CD 11 or a recording medium, on which music data is recorded along its pit train formed along cocentrical tracks, is driven at a constant line speed by a spindle motor (not shown). A pickup 12 emits a laser beam onto the driven CD 11 and detects and outputs changes of a reflected light depending on the presence of pit at a speed which is twice a reproducing speed. CD-DSP 13 is a signal processing circuit which processes a driving signal for driving the pickup 12 and a signal read out from the pickup 12. CD-DSP 13 includes an error correction circuit (not shown) corrects errors in music data and a digital to analog converter (DAC) circuit (not shown) for converting a digital signal of the music data to an analog waveform signal.

A shock memory 14 and a memory controller 15 provide a shock-proof reproducing function. More particularly, the memory controller 15 writes the music data read out from CD 11 and processed by CD-DSP 13 onto the shock memory 14 at a rate which is twice a reproducing rate, and reads out and outputs to CD-DSP 13 at the reproducing rate. In CD-DSP 13, DAC circuit converts the music data input from the memory controller 15 into an analog signal to output a CD reproduced audio signal. CPU 16 controls CD-DSP 13 and the memory controller 15, and detects whether a CD cover switch 17 has been turned on or not. CPU 16 communicates with the electronic instrument system 18 to exchange a command and data. Thought not shown, CPU 16 is an one-chip LSI which comprises ROM on which a program for reproducing and processing data, a communication program for communicating with the electronic instrument system 18, and initial data used at initialization are stored, and RAM having registers and flags.

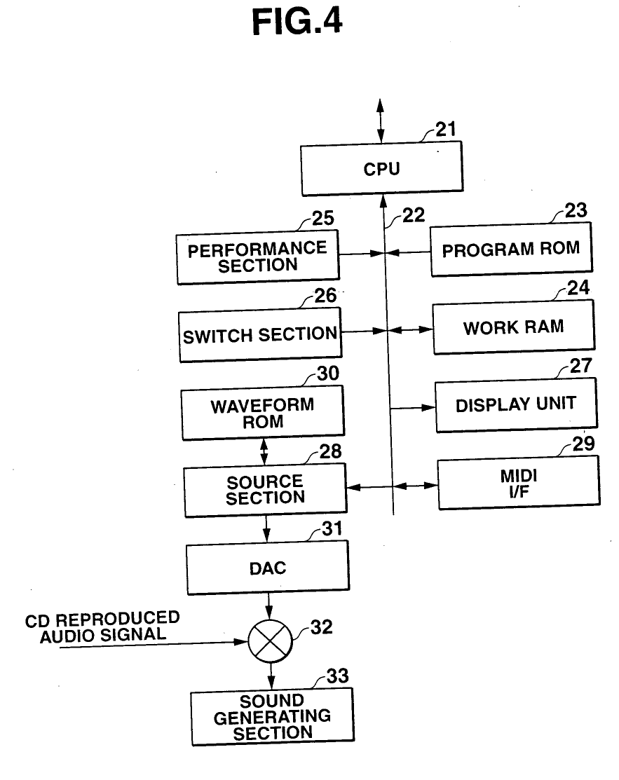

FIG. 4 is a block diagram illustrating an internal configuration of the electronic instrument system 18 shown in FIG. 3. CPU 21 communicates with CPU 16 shown in FIG. 3, and is connected through a system bus 22 with a program ROM 23, a work RAM 24, a performance section 25, a switch section 26, a display unit 27, a sound source section 28 and MIDI interface 29 to exchange a command and data with them. The program ROM 23 stores a communication program for communicating with CPU 16 of FIG. 3, a control program for controlling the electronic instrument system, and initial data used when the power is turned on. The work RAM 24 temporarily stores data to be processed by CPU 21. The performance section 25 corresponds to the keyboard 1 shown in FIG. 1 and/or the drum pad 9 shown in FIG. 2, and inputs to CPU 21 performance data in response to performance played by a user. The switch section 26 corresponds to the switch sections 2 and 7 shown in FIGS. 1 and 2, and inputs to CPU 21 on or off command in response to the user's operation. The display unit 27 corresponds to the display unit 3 and/or LED 8, and displays a message and data under display-control of the CPU 21. LED 8 is turned on or off under control of CPU 21. The MIDI interface 29 exchanges MIDI data with an external MIDI apparatus.

The sound source section 28 reads out a digital waveform data from a waveform ROM 30 and inputs the same to DAC 31 under sound-control of CPU 21. DAC 31 converts the digital waveform data to an audio signal and inputs the same to a mixer 32. The mixer 332 combines the audio signal from DAC 31 and the CD reproduced audio signal input from the CD-DSP 13 of FIG. 3, and inputs the combined signal to a sound generating section 33 to generate a sound. The sound generating section 33 includes a filter circuit (not shown), an amplifying circuit (not shown) and the speaker 4 shown in FIGS. 1 and 2.

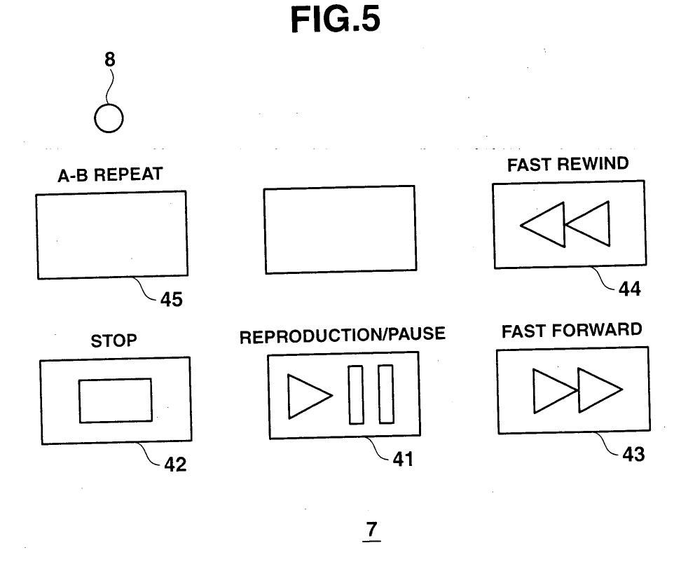

FIG. 5 is an enlarged view showing the switch section 7 for operating CD and LED 8 shown in FIGS. 1 and 2. The switch section 7 comprises a reproduction/pause switch 41, a stop switch 42, a fast forward switch 43, a fast-rewind switch 44, and a repeat switch 45. CPU 21 sends a control command to CPU 16 in response to operation of each of the switches. Therefore, CPU 16 performs processes as if operation of the switch is directly input.

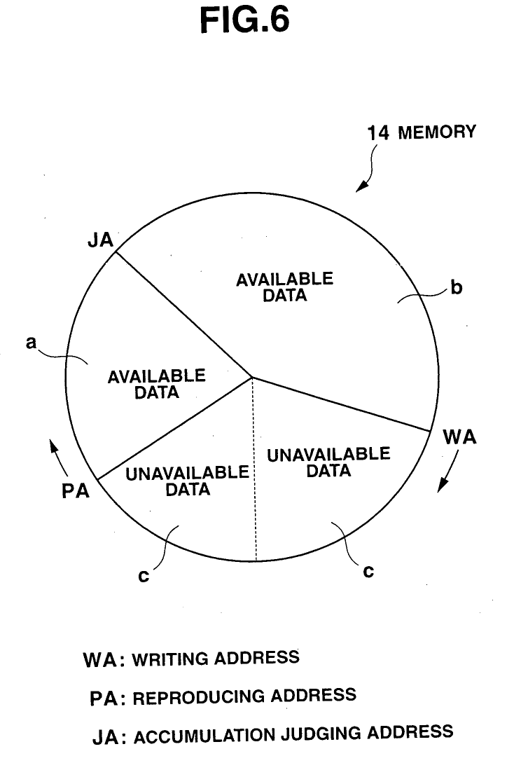

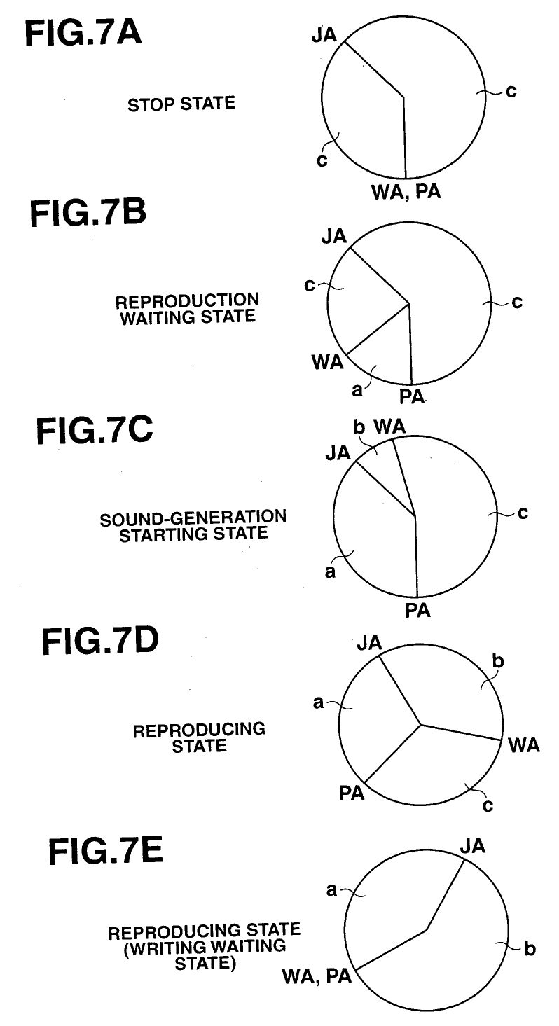

Now, operation of the data reproducing apparatus used in the embodiment will be described. Structure of addresses and data in the shock memory 14 will be described with reference to FIGS. 6 and 7. The shock memory 14 is a ring buffer, address of which changes circularly. When the address is incremented, data previously written therein is replaced with newly written data. FIG. 6 is a view showing a relationship between the address of the shock memory 14 and data. In FIG. 6, a reference sign “WA” denotes a writing address of the shock memory 14 where data is written, and a reference sign “PA” denotes a reproducing address of the shock memory 14 where data is read out. A position indicated by a broken line represents a writing address “WA” designated at the time when reproduction starts and a start address of the reproducing address “PA”. An address “JA” is an accumulation judging address, which is one of the features of the present invention, and is obtained by adding a predetermined number of addresses to the writing address “WA” of the time when reproduction starts.

In general, since an increment rate of the writing address “WA”, i.e., a writing rate is set to a rate which is twice an increment rate of the reproducing address “PA”, i.e., a reproduction rate, the writing address “WA” precedes the reproducing address “PA”. Therefore, data between the writing address “WA” and the reproducing address “PA” is available data which has not been reproduced. But the reproducing address “PA” stays at the starting address and remains in a reproduction waiting state before the writing address WA reaches the accumulation judging address “JA”. After the writing address WA reaches the accumulation judging address “JA”, reading data from the shock memory 14 starts and the reproducing address “PA” is incremented. Therefore, in the data state shown in FIG. 6, an area “a” defined by the reproducing address “PA” and the accumulation judging address “JA” and an area “b” defined by the accumulation judging address “JA” and the writing address “WA” represent available data. An area “c” defined by the writing address “WA” and the starting address represents unavailable data, because the data was previously written in and old. An area “c” defined by the starting address and the reproducing address “PA” represents unavailable data, because the data has been already read out to generate a corresponding sound at the starting time of reproduction.

FIG. 7A through FIG. 7E are views showing addresses and data of the shock memory 14 corresponding respectively to state transitions of CPU 16. In a stop state shown in FIG. 7A, both the writing address “WA” and the reproducing address “PA” stays at the starting address. In this state, data stored at all the area of the shock memory 14 is unavailable data. FIG. 7B is a view showing a state in which data is written into the shock memory 14 in the reproduction waiting state. That is, when CPU 16 transits to a reproducing state, data is read out from CD 11 by the pickup 12 and output from CD-DSP 13 to be written into the shock memory 14. Data in an area “a” defined by the reproducing address “PA” at the starting address and the writing address “WA” is available data, but the available data is not yet read out from the shock memory 14 because the writing address “WA” has not yet reached the accumulation judging address “JA”.

In a sound-generation starting state shown in FIG. 7C, since the writing address “WA” has reached the accumulation judging address “JA”, the reproducing address “PA” is incremented to read out data. The read out data is supplied to the electronic instrument system 18 for generating a sound.

In a reproducing state shown in FIG. 7D, data is read out from the shock memory 14 as the reproducing address “PA” is incremented. The read out data is supplied to the electronic instrument system 18 for generating a sound.

In the reproducing state shown in FIG. 7E, the writing address “WA” has caught up to the reproducing address “PA”, and all the area of the shock memory 14 is full of data and CPU 16 is in a writing waiting state. In this writing waiting state, the pickup 12 is brought to a pause state and stays at a position on CD 11 where the pickup 12 has finished reading data.

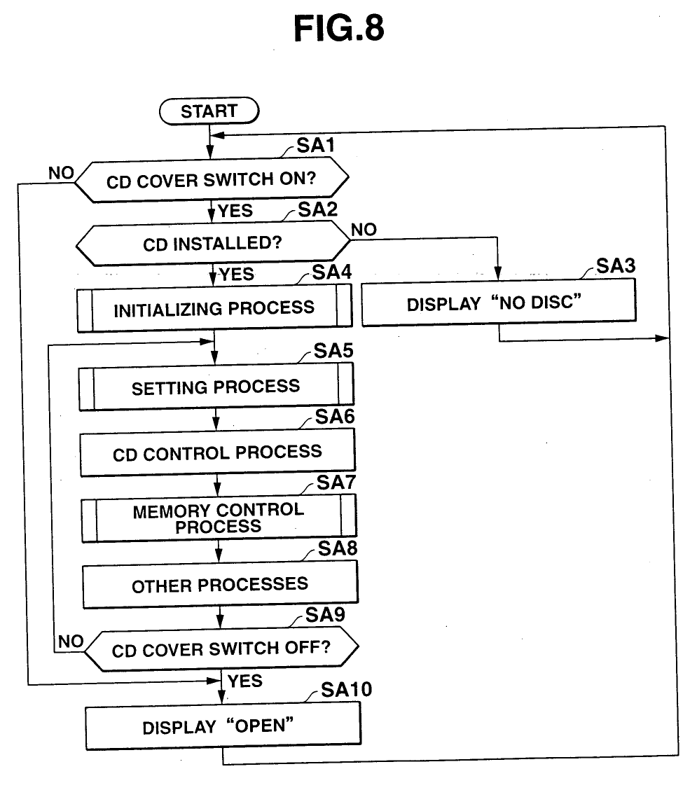

Now, a data reproducing process to be performed by CPU 16 and the memory controller 15 will be described with reference to FIG. 8 thorough FIG. 15.

FIG. 8 is a flow chart of a main routine process. At step SA1 it is judged whether the CD cover switch is turned on or not. When the CD cover switch is turned on, it is judged at step SA2 whether CD is installed or not. When CD has not been installed, a notice of “NO DISC” is displayed at step SA3 and the operation returns to step SA1, where it is judged whether the CD cover switch is turned on or off.

When it is determined at step SA2 that CD has been installed, an initializing process is executed at step SA4. Then, a setting process, CD control process, a memory control process, and other processes are executed respectively at steps SA5, SA6, SA7, and SA8. In the CD control process, CD is driven, and a reproducing process, a stop process, a fast forward process, a fast rewind process and a pause process are executed in response to manipulation of the switches shown in FIG. 5. The initializing process, setting process and memory control process will be described in detail later. After the other processes have been executed at step SA8, it is judged at step SA9 whether the CD cover switch is turned off. When it is determined at step SA9 that the CD cover switch is not turned off, the processes at step SA5 through step SA9 are repeatedly executed. When it is determined at step SA9 that the CD cover switch is turned off, or when it is determined at step SA1 that the CD cover switch is turned off, a notice of “OPEN” is displayed step SA10 and the operation returns to step SA1, where it is judged whether the CD cover switch is turned on or off.

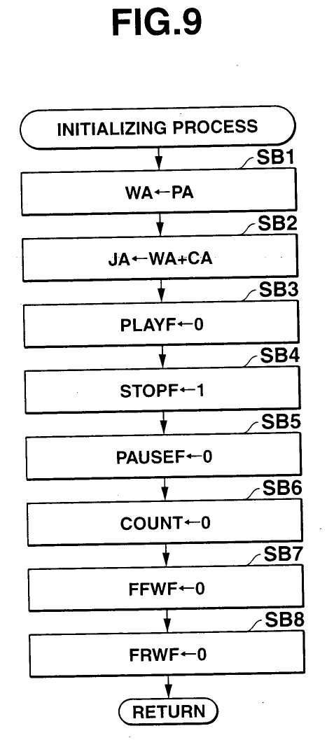

FIG. 9 is a flow chart showing the initializing process at step SA4 in the main routine process shown in FIG. 8. In the process of FIG. 9, the writing address “WA” is set to the same starting address as the reproducing address “PA” at step SB1. The accumulation judging address “JA” is determined at step SB2 by adding a certain address difference “CA” to the writing address “WA”. The certain address difference “CA” corresponds to a certain number of addresses, by which the address is incremented while operation the pickup 12 transits from a transient state to a steady state. Then, a reproducing flag PLAYF is reset to “0” at step SB3, and a stop flag STOPF is set to “1” at step SB4, and then a pause flag PAUSEF is reset to “0” at step SA5. Further, a register COUNT is cleared to “0” at step SB 6, which register is for counting data volume accumulated on the shock memory 14. A fast forward flag FFWF is reset to “0” at step SB7, and a fast-rewind flag FRWF is reset to “0” at step SB8, and then the operation returns to the main routine process.

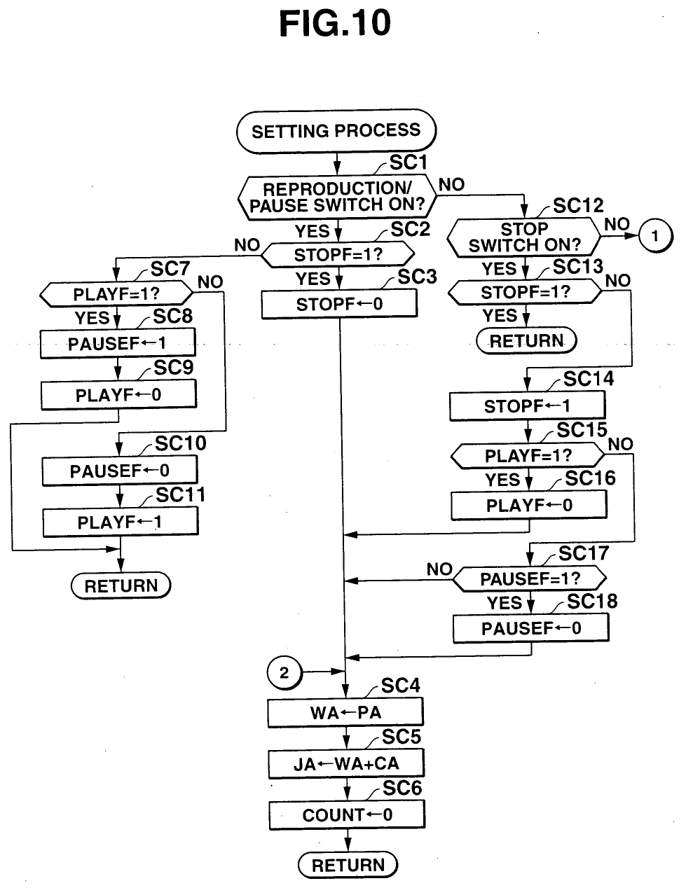

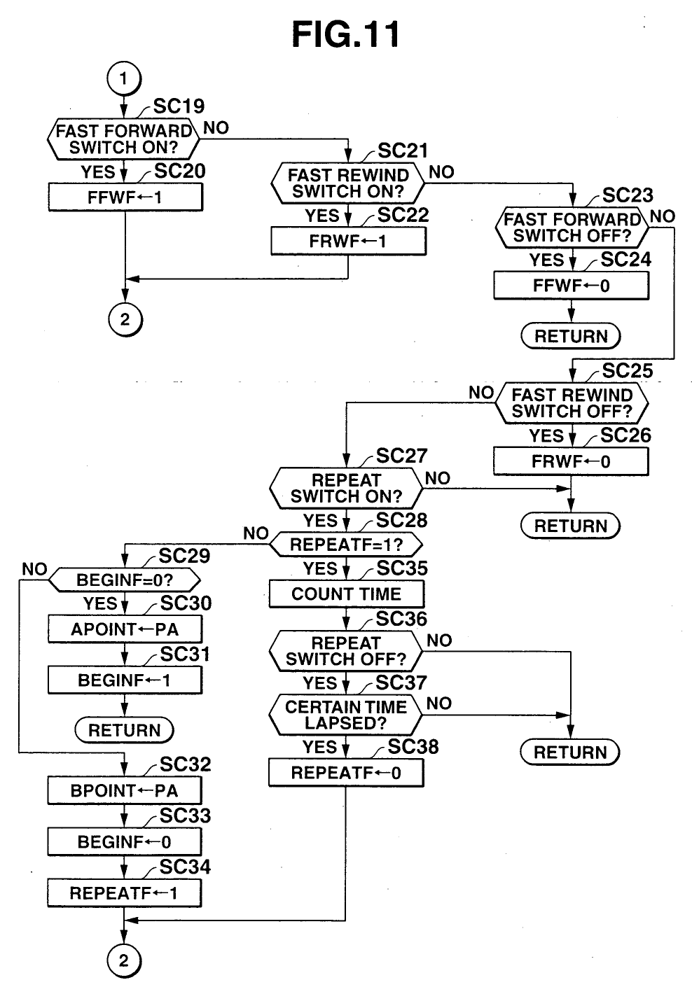

FIG. 10 and FIG. 11 are flow charts showing the setting process at step SA 5 in the main routine process of FIG. 8. In the setting process, various processes are executed in response to manipulation of the switches shown in FIG. 5. At step SC1, it is judged whether a reproduction/pause switch is turned on or not. When the reproduction/pause switch is turned on, it is judged at step SC2 whether the stop flag STOPF is set to “1” or not. When the stop flag STOPF is set to “1” and CPU 16 is in the stop state, the writing address “WA” is set to the same starting address as the reproducing address “PA” at step SC4, and the accumulation judging address “JA” is set at step SC5 by adding a certain address difference “CA” to the writing address “WA”. The register COUNT is cleared to “0” at step SC6 and then the operation returns to the main routine process.

When it is determined at step SC2 that the stop flag STOPF is set to “0”, it is judged at step SC7 whether or not the reproducing flag PLAYF is set to “1”. When it is determined at step SC7 that the reproducing flag PLAYF is set to “1”, since the reproduction/pause switch is turned on in the reproducing state, CPU 16 transits from the reproducing state to the pause state, and sets the pause flag PAUSEF to “1” at step SC8 and resets the reproducing flag PLAYF to “0” at step SC9. Then the operation returns to the main routine process. When it is determined at step SC7 that the reproducing flag PLAYF is set to “0”, since the reproduction/pause switch is turned on in the pause state, CPU 16 transits from the pause state to the reproducing state and resets the pause flag PAUSEF to “0” at step SC10 and sets the reproducing flag PLAYF to “1” at step SC11. Then the operation returns to the main routine process.

When it is determined at step SC1 that the reproduction/pause switch is not turned on, it is judged at step SC12 whether or not the stop switch is turned on. When the stop switch is turned on, it is judged at step SC13 whether the stop flag STOPF is set to “1” or not. When the stop flag STOPF is set to “1”, since CPU 16 has been brought in the stop state, on-manipulation of the stop switch gives no effect and the operation immediately returns to the main routine process. When the stop flag STOPF is set to “0”, since CPU 16 is in the reproducing state or in the pause state, the stop flag STOPF is set to “1” at step SC14 and it is judged at step SC15 whether the reproduction flag PLAYF is set to “1” or not. When the reproduction flag PLAYF is set to “1”, the reproduction flag PLAYF is reset to “0” at step SC16. When the reproduction flag PLAYF is set to “0”, it is judged at step SC17 whether the pause flag PAUSEF is set to “1” or not. When the pause flag PAUSEF is set to “1”, the pause flag PAUSEF is reset to “0” at step SC18. After the pause flag PAUSEF has been reset to “0”, or after the pause flag PAUSEF has been reset to “0”, the writing address “WA” is set to the same starting address as the reproducing address “PA” at step SC4, and the accumulation judging address “JA” is set by adding a certain address difference CA to the writing address “WA” at step SC5. The register COUNT is reset to “0” at step SC6 and the operation returns to the main routine process.

When it is determined at step SC12 that the stop switch is not turned on, it is judged at SC19 (FIG. 11) whether the fast forward switch has been manipulated or turned on. When the fast forward switch is turned on, the fast forward flag FFWA is set to “1” at step SC20. When it is determined at step SC19 that the fast forward switch is not turned on, it is judged at step SC21 whether or not the fast-rewind switch is turned on. When the fast-rewind switch is turned on, the fast-rewind flag FRWF is set to “1” at step SC22. After the fast forward flag FFWF has been set to “1”, or after the fast-rewind flag FRWF has been set to “1”, the writing address “WA is set to the same address as the reproducing address “PA” at step SC4 (FIG. 10) and the accumulation judging address “JA” is set by adding a certain address difference “CA” to the writing address “WA” at step SC5 (FIG. 10). The register COUNT is cleared to “0” at step SC6 and the operation returns to the main routine process.

When it is determined at step SC21 (FIG. 11) that the fast-rewind switch is not turned on, it is judged at step SC23 whether the fast forward switch is turned off or not. When the fast forward switch is turned off, the fast forward flag FFWF is reset to “0” at step SC24. When the fast forward switch is not turned off, it is judged at step SC25 whether the fast-rewind switch is turned off. When the fast-rewind switch is turned off, the fast-rewind flag FRWF is reset to “0” at step SC26. After the fast forward flag FFWF is reset to “0” or after the fast-rewind flag FRWF is reset to “0”, the operation returns to the main routine process.

When it is determined at step SC25 that the fast-rewind switch is not turned off, it is judged at step SC27 whether the repeat switch is turned on or not. When the repeat switch is turned on, it is judged at step SC28 whether a repeat flag REPEATF is set to “1” (Repeat setting) or not. When the repeat flag REPEATF is set to “0”, it is judged at step SC29 whether a repeat starting-point flag BEGINF is set to “0”. When the repeat starting-point flag BEGINF is set to “0”, the reproducing address “PA” is stored in a register APOINT to set a starting address of a repeat reproduction at step SC30. Then, the repeat starting-point flag BEGINF is set to “1”, and LED 8 is made to flash at step SC31. The operation returns to the main routine process. When it is determined at step SC29 that the starting-point flag BEGINF is set to “1”, the reproducing address “PA” is stored in a register BPOINT to set a terminal address of the repeat reproduction at step SC32. Then, the repeat starting-point flag BEGINF is reset to “0” at step SC33, and the repeat flag REPEATF is set to “1” at step SC34 to make LED 8 flash. The operation returns to the main routine process.

When it is determined at step SC28 that the repeat flag REPEATF is set to “1”, a time counting operation starts at step SC35. It is judged at step SC36 whether the repeat switch is turned off or not. When the repeat switch is not turned off, the operation returns to the main routine process. When the repeat switch is turned off, it is judged at step SC37 whether a certain time has lapsed or not. When a certain time has not lapsed, the operation returns to the main routine operation. When a certain time has lapsed, that is, when the repeat switch has been kept on for more than a certain time, the repeat flag REPEATF is reset to “0” and LED 8 is turned off at step SC38. The repeat reproduction is terminated and the operation returns to the main routine process.

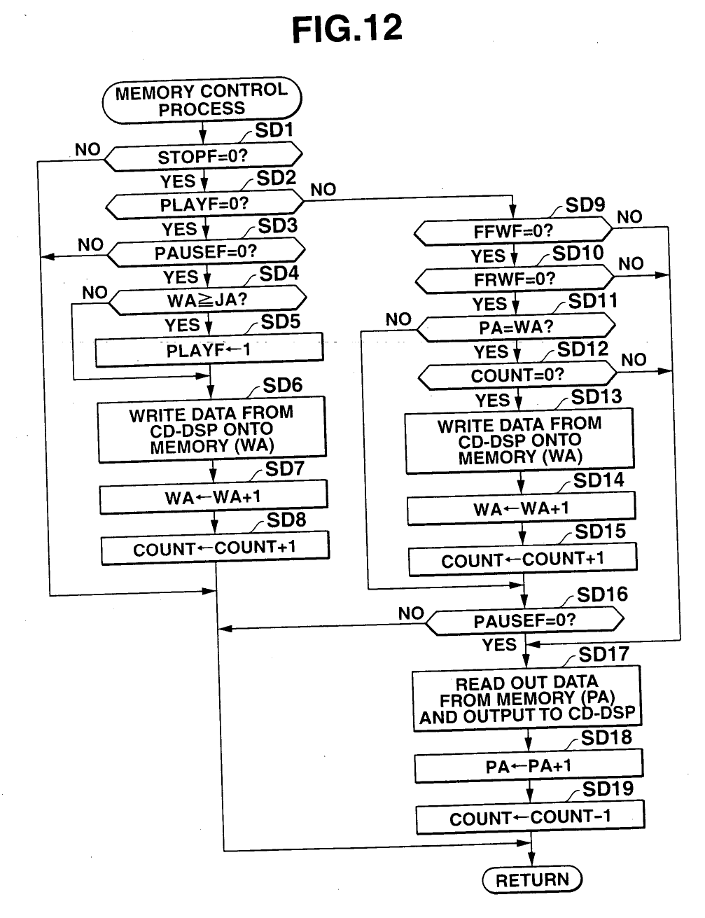

FIG. 12 is a flow chart of the memory control process to be executed at step SA7 in the main routine process of FIG. 8. At step SD1, it is judged whether the stop flag STOPF is set to “0” or not. When the stop flag STOPF is set to “1”, the shock memory 14 is in the stop state shown in FIG. 7A, and since no data to be read out is available, the operation returns to the main routine process. When the stop flag STOPF is set to “0”, it is judged at step SD2 whether the reproduction flag PLAYF is set to “0” or not. When the reproduction flag PLAYF is set to “0”, the shock memory 14 is in the reproduction waiting state or the pickup 12 is in the pause state where the pickup 12 is temporarily out of operation. Therefore, it is judged at step SD3 whether the pause flag PAUSEF is set to “0” or not. When the pause flag PAUSEF is set to “1”, the operation returns to the main routine process.

Meanwhile, when the pause flag PAUSEF is set to “0”, since CPU 16 is in the reproduction waiting state, it is judged at step SD4 whether the writing address “WA” has reached the accumulation judging address “JA” or not. In other words, it is judged whether or not data read out from CD by the pickup 12 is processed in the CD-DSP13 and written into the shock memory 14 by the memory controller 15, and further judged whether or not the writing address “WA” is incremented (FIG. 7B) and has reached the accumulation judging address “JA”. When the writing address “WA” has reached the accumulation judging address “JA”, the reproduction flag PLAYF is set to “1” at step SD5. That is, CPU 14 transits from the reproduction waiting state (FIG. 7B) to the sound-generation starting state (FIG. 7C). When the writing address “WA” has not reached the accumulation judging address “JA”, or after the reproduction flag PLAYF is set to “1”, data input from CD-DSP13 is written into the shock memory 14 at the writing address “WA” at step SD6. The writing address “WA” is incremented at step SD7, and a value of the register COUNT for counting available data in the shock memory 14 is incremented at step SD8. Then, the operation returns to the main routine process.

When it is determined at step SD2 that the reproduction flag PLATF is set to “1”, CPU 16 is in the normal reproducing state or the pickup 12 is moving fast in a fast reproducing or fast rewinding state. Therefore, it is judged at step SD9 whether the fast forward flag FFWF is set to “0”. When the fast forward flag FFWF is set to “0” and CPU 16 is not in the fast reproducing state, it is judged at step SD10 whether the fast-rewind flag FRWF is set to “0” or not. When the fast-rewind flag FRWF is set to “0”, CPU 16 in the normal reproducing state. In this case, it is judged at step SD11 whether or not the reproducing address “PA” is at the same address as the writing address “WA”.

When the reproduction flag PLAYF is set to “1” and when the reproducing address “PA” is at the same address as the writing address “WA”, there can be two states. In one state, the writing address “WA” has caught up the reproducing address “PA”, as shown in FIG. 7E. In other state, on the contrary, the reproducing address “PA” has caught up the writing address “WA”. In general, since the writing address “WA” is twice the incrementing rate of the reproducing address “PA”, the reproducing address “PA” can not catch up the writing address “WA”. But when data which is read out from CD by the pickup 12 and input to CD-DSP 13 is not normal, data is read out by the pickup 12 again. Therefore, in case that abnormal data is read out continuously, data-input process for inputting data from CD-DSP 13 to the memory controller 15 is interrupted. Even in such case, data is continuously readout from the shock memory 14 to keep generating a sound. As a result, the reproducing address “PA” can catch up the writing address “WA”.

Therefore, when the reproducing address “PA” is at the same address as the writing address “WA”, it is necessary to judge whether or not the writing address “WA” catches up the reproducing address “PA” and the shock memory 14 is full of available data, or it is necessary to judge whether or not the reproducing address “PA” catches up the writing address “WA” and there is no available data in the shock memory 14. For that purpose, it is judged at step SD12 whether or not the register COUNT for counting available data in the shock memory 14 is set to “0”. When the register COUNT is set to “0”, since there is left no available data in the shock memory 14, data input from CD-DSP 13 is written into the shock memory 14 at the writing address “WA” at step SD13. Then the writing address “WA” is incremented at step SD14, and a value of the register COUNT is incremented at step SD15.

After the value of the register COUNT has been incremented, or when it is determined at step SD11 that the reproducing address “PA” is not at the same address as the writing address “WA”, it is judged at step SD16 whether or not the pause flag PAUSEF is set to “0”. When the pause flag PAUSEF is set to “1”, data is not read out from the shock memory 14, and the operation returns to the main routine process. Meanwhile, when the pause flag PAUSEF is set to “0”, data at the reproducing address “PA” of the shock memory 14 is read out, and output to CD-DSP 13 at step SD17 to make the electronic instrument system generate a sound. Then the reproducing address “PA” is incremented at step SD18, and a value of the register COUNT is decremented at step SD19. The operation returns to the main routine process.

When it is determined at step SD12 that the register COUNT is not set to “0”, or when the writing address “WA” has caught up the reproducing address “PA” and the shock memory 14 is full of available data, operation for writing data into the shock memory 14 is interrupted and only operation for reading data from the shock memory 14 is executed. In other words, data is read out from the reproducing address “PA” of the shock memory 14 and output to CD-DSP 13 at step SDS17, and then the reproducing address “PA” is incremented at step SD18 and the value of the register COUNT is decremented at step SD19. Then the operation returns to the main routine process. It should be noted that the pickup 12 temporarily stops at a position where it finished reading CD and is brought to a reading waiting state in the CD control process at step SA6 in FIG. 8.

As described above, CPU 16 and the memory controller 15 in the embodiment increments the writing address “WA” from the starting address every time data is written in the shock memory 14, and increments the reproducing address “PA” from the starting address every time data is read out from the shock memory 14 and writes data read out by the pickup 12 to the writing address “WA” of the shock memory 14. CPU 16 and the memory controller 15 suspend operation of reading out data from the shock memory 14 until the writing address “WA” reaches the accumulation judging address “PA”, and start operation of reading out data from the reproducing address “PA” of the shock memory 14 when the writing address “WA” has reached the accumulation judging address “PA”. Therefore, generation of a disconnected sound can be prevented during the transient state of the pickup 12 from the stop state, the fast forward state, or the fast rewind state to the reproducing state.

The memory controller 15 uses the shock memory 14 as a ring buffer, and executes an address control operation to circularly increment the writing address “WA” and the reproducing address “PA”, thereby replacing previously written data with another data to be newly written. Therefore, even though vast amount of data is read out form CD 11, there is no need to use a memory having a large memory capacity, which will contribute to reduce cost of the device and to make the device more compact in size and light in weight.

In response to a control command requesting to start data reproduction, the memory controller 15 adds a certain number of addresses “CA” to the start address, that is, the writing address “WA” to set the accumulation judging address “JA”. The address “CA” is equivalent to a number of addresses to be incremented while the pickup 12 transits from the transient state to the normal state. Therefore, since data is read out from the shock memory 14 to generate a sound, which data is read out from CD and stored in the shock memory 14 after a time period has lapsed during which a tracking control operation and a focus control operation are unstable so that a disconnected sound can be caused often, the generation of a disconnected sound is prevented.

In the above mentioned embodiment, the data reproducing apparatus according to the present invention has been described, which is applied to the electronic keyboard instrument of FIG. 1 and the electronic drum instrument of FIG. 2, but the data reproducing apparatus according to the present invention may be used for a portable type CD player, too. When a user manipulates the CD player while he or she is walking or moving, the pickup often receives vibration and generates a disconnected sound. Employment of the present data reproducing apparatus will effectively prevent generation of such disconnected sound, in the same manner as described in the above embodiments.

The data reproducing apparatus according to the present invention is not to be applied only to such an apparatus as reproducing music data recorded on CD, such as the electronic keyboard instrument, the electronic drum instrument, and the portable type CD player. In a data reproducing apparatus for reading out and reproducing data from various discs including DVD, CD-ROM, CD-R, CD-RW and MD, which store content data other than music data, such as image data and text data, since a tracking control operation and a focus control operation are unstable in a transit state of a pickup from its transient state to its steady state, external shock or vibration can often cause abnormalities in reproduced data. Therefore, the data reproducing apparatus according to the present invention can prevent generation of abnormalities in the reproduced data in the data reproducing apparatus with a pickup for reproducing data.

In the above mentioned embodiment, the invention of the apparatus has been describe, in which CPU 16 executes the program for performing a data reproducing operation, previously stored in the data reproducing apparatus. The apparatus may be modified such that CPU 16 of the apparatus executes the program for performing a data reproducing operation, stored in a memory into which the program can be written from an external medium. Further, the apparatus may be modified such that the apparatus is provided with a communication interface for accessing to a network such as the Internet and downloads from an external server through the communication interface and writes into a rewritable memory the program for performing a data reproducing operation, and CPU 16 executes the downloaded program. In this case, an invention of program maybe realized.

1. A data reproducing apparatus comprising:
data-reading means for reading out data from a recording medium;
command generating means for generating a control command for controlling data-reading operation of the data-reading means;
address control means for incrementing a writing address from a starting address every time when data is written into a predetermined memory, and for incrementing a reproducing address from a starting address every time when data is read out from the memory, thereby setting predetermined addresses;
writing control means for writing the data read out by the data-reading means to the writing address in the memory in accordance with a control command generated by the command generating means, requesting to start operation for reproducing data; and
reading control means for suspending operation for reading out data from the memory until the writing address reaches the predetermined address set by the address control means, and for starting operation for reading out data from the reproducing address in the memory when the writing address reaches the predetermined address.

2. The data reproducing apparatus according to claim 1, wherein the address control means performs address-controlling operation for circularly incrementing the writing address and the reproducing address in the memory to renew data previously written into the memory with new data to be written therein.

3. The data reproducing apparatus according to claim 1, wherein the address control means adds to the starting address the number of addresses which are incremented while the data-reading means transits from its transient state to its steady state, in accordance with a control command generated by the command generating means, requesting to starting data-reproducing operation, thereby setting the predetermined address.

4. The data reproducing apparatus according to claim 1, wherein the control command generated by the command generating means demands that the data-reading means reads out music data recorded on the recording medium.

5. A program for performing a data reproducing process comprising:
a first step of performing data-reading operation to read out data from a recording medium;
a second step of performing command-generating operation to generate a control command for controlling the data-reading operation of the first step;
a third step of performing address-control operation to increment a writing address from a starting address every time when data is written into a predetermined memory, and to increment a reproducing address from a starting address every time when data is read out from the memory, thereby setting predetermined addresses;
a forth step of writing the data read out at the first step to the writing address in the memory in accordance with a generated control command of requesting to start data-reproducing operation; and
a fifth step of suspending operation for reading out data from the memory until the writing address reaches the predetermined address set at the third step, and of starting operation for reading out data from the reproducing address in the memory when the writing address reaches the predetermined address.

6. The program according to claim 5, wherein the address-control operation of the third step circularly increments the writing address and the reproducing address of the memory to renew data previously written into the memory with new data to be written therein.

7. The program according to claim 5, wherein the address-control operation of the third step adds to the starting address the number of addresses which are incremented while the data-reading operation transits from its transient state to its steady state, in accordance with a generated control command of requesting to start data-reproducing operation, thereby setting the predetermined address.

8. The program according to claim 5, wherein the command generating operation of the second step generates the control command for demanding that the data-reading operation of the first step reads music data.
